(19) United States
(12) Patent Application Publication
(10) Pub. No.: US 2011/0081548 A1
(43) Pub. Date: Apr. 7, 2011

(54) ZINC OXIDE PARTICLE, METHOD FOR PRODUCING IT, EXOERGIC FILLER, EXOERGIC RESIN COMPOSITION, EXOERGIC GREASE AND EXOERGIC COATING COMPOSITION

(75) Inventors: Satoru Sueda, Fukushima (JP); Atsuki Terabe, Fukushima (JP); Hiroyuki Izumikawa, Fukushima (JP); Mitsuo Hashimoto, Fukushima (JP)

(73) Assignee: Sakai Chemical Industry Co., Ltd., Osaka (JP)

(21) Appl. No.: 12/579,925

(22) Filed: Oct. 15, 2009

(30) Foreign Application Priority Data
Oct. 7, 2009 (JP) 2009-233401
Oct. 14, 2009 (JP) 2009-237305

(51) Int. Cl. C01G 9/02

(52) U.S. Cl. 428/402; 423/622

(57) ABSTRACT

The object of the present disclosure is to obtain zinc oxide particle having large particle diameter and being high-density and to obtain an exoergic resin composition, an exoergic grease and an exoergic coating composition that show an excellent exoergic property by using it.

A zinc oxide particle being high-density, which has density of 4.0 g/cm³ or more and median size (D50) of 17 to 10000 μm.

### TECHNICAL FIELD

The present disclosure relates to a zinc oxide particle having large particle diameter that can be used in the fields such as exoergic fillers, rubber accelerators, pigments for coating compositions and inks, such electronic components as ferrite and varistor, medicinal products and such cosmetics as foundations and sun screens, a method for producing it, an exoergic filler, an exoergic resin composition, an exoergic grease and an exoergic coating composition.

### BACKGROUND OF THE DISCLOSURE

Zinc oxide is widely used in the various industrial fields such as rubber accelerators, pigments for coating compositions and inks, such electronic components as ferrite and varistor, medicinal products and cosmetics. As one of various applications of this zinc oxide, an exoergic filler has been proposed (see Patent Documents 1 to 4).

However, alumina and aluminum nitride are usually used widely as the exoergic filler. Therefore, the zinc oxide is put into actual utilization less than these fillers.

However, alumina has a problem that kneading machines become extremely worn in the production process of exoergic sheets and so on, because Mohs hardness of alumina is high. Further, it is difficult to add aluminum nitride to a resin in high concentration, because of poor filling property. In addition, aluminum nitride is expensive, so exoergic parts made thereof is expensive. Therefore, new exoergic fillers which are made of other materials than such conventional materials are needed.

Zinc oxide has almost intermediate thermal conductivity between alumina and aluminum nitride and is suitable for use as an exoergic filler. However, zinc oxide that is used widely for industrial use is a fine particle having a particle diameter of 1 μm or less and such zinc oxide is infrequently-used because interfacial area of the particle increases, leading to increase in thermal resistance between each particle and degradation in exoergic property. It is not preferred because the fine particle having a particle diameter of 1 μm or less has large surface area and the viscosity of a resin composition comprising the particle increases to make impossible for the fine particle to mix in high concentration. The particle diameter of zinc oxide is preferably larger because it can be expected that heat transfer route in the resin composition is increased as the particle diameter grow larger and improvement in heat transfer derived from closest-packing effect is attained by combination other filler. Further, it is preferred from a point of view of high heat transfer property to have less hole and high density.

Concerning zinc oxide particles having a median size (D50) of 20 to 120 μm, the one disclosed in Patent Document 5 for varistor is publicly known. When the zinc oxide particle is used as an exoergic filler, it is needed for the zinc oxide particle to have a large particle diameter and have high density of particle inside. However, the zinc oxide particle disclosed in Patent Document 5 has the following characteristics; (1) it shows an aggregate-like shape and has many unevenness and fine pores, so uniform particles can not be obtained; (2) the zinc oxide is designed to increase the number of primary crystal grains at the surface of the particle and inside thereof by adding 5.3 to 14.5 mol % of accessory component in addition to zinc oxide of the main component for increasing the varistor property. For making the zinc oxide more suitable as the exoergic filler, it is preferred to increase degree of purity of the zinc oxide of the main component, clear the unevenness and fine pores at the surface of zinc oxide and decrease the grains at the surface of the particle and inside thereof to be densified. Therefore, the zinc oxide particle disclosed in Patent Document 5 is not intended for the use as the exoergic filler.

As a spherical zinc oxide particle, the one that proposed for the field of functional materials such as varistor (Patent Document 5) and self-cleaning powder (Patent Document 6) which show ultraviolet absorption effect, catalyst effect, antibacterial effect or conductive effect is publicly known. However, it was hard to obtain a zinc oxide particle being spherical and high-density and having a median size (D50) of 17 to 10000 μm by using the above technology.

The method for producing a spherical zinc oxide particle having particle diameter of 1 to 50 μm by baking an organozinc compound has been proposed (Patent Document 7). However, a spherical particle could be obtained by using the technology, it could not to obtain spherical particles selectively because confetti-shaped particles were produced at the same time. The inventor of the present disclosure made an additional test and it found that the particle size distribution of the obtained particle was measured and the median size (D50) was several micrometer, so particles having median size (D50) of 10 μm or more could not obtained.

### PRIOR TECHNICAL DOCUMENT

### Patent Document

[Patent Document 1] Japanese Kokai Publication 2008-19426
[Patent Document 2] Japanese Kokai Publication Hei11-246885
[Patent Document 3] Japanese Kokai Publication 2007-70492
[Patent Document 4] Japanese Kokai Publication 2002-201483
[Patent Document 5] Japanese Kokai Publication 2008-218749
[Patent Document 6] Japanese Kokai Publication 2009-29690
[Patent Document 7] Japanese Kokai Publication Hei11-49516

### SUMMARY OF INVENTION

### Problem to be Solved by the Invention

The object of the present disclosure which has been in view of the above-mentioned state of the art, is to obtain zinc oxide particle having large particle diameter and being high-density and to obtain an exoergic resin composition, an exoergic grease and an exoergic coating composition that show, an excellent exoergic property by using it.

### Means for Solving Object

The present disclosure relates to a zinc oxide particle being high-density, which has density of 4.0 g/cm³ or more and median size (D50) of 17 to 10000 μm.

The present disclosure relates to a method for producing a zinc oxide particle, comprising a step (1) of mixing a source of the zinc oxide particle with at least one compound selected from the group consisting of organic acids, organic bases, inorganic acids, inorganic bases, and salts thereof not containing a halogen to granulate, and a step (2) of baking the granulated particle obtained in said step (1) to obtain the zinc oxide particle, too.

The organic acid, organic base, inorganic acid, inorganic base, or salt thereof is preferably carboxylic acid, nitric acid or salts thereof.

The present disclosure relates to an exoergic filler comprising the zinc oxide particle.

The present disclosure relates to an exoergic resin composition comprising the zinc oxide particle.

The present disclosure relates to an exoergic grease comprising the zinc oxide particle.

The present disclosure relates to an exoergic coating composition comprising the zinc oxide particle.

### Effect of the Invention

The zinc oxide particle of the present disclosure is large particle and high density, so it has high exoergic property and is used as the exoergic filler especially suitably. Therefore, it has become possible to obtain an exoergic resin composition, an exoergic grease, and exoergic coating composition that have an excellent exoergic property by using it.

### BRIEF DESCRIPTION OF THE DRAWINGS

FIG. 1 is a scanning electron microscope photograph of zinc oxide particles of the present disclosure obtained in Example 1.

FIG. 2 is a scanning electron microscope photograph of zinc oxide particles of the present disclosure obtained in Example 2.

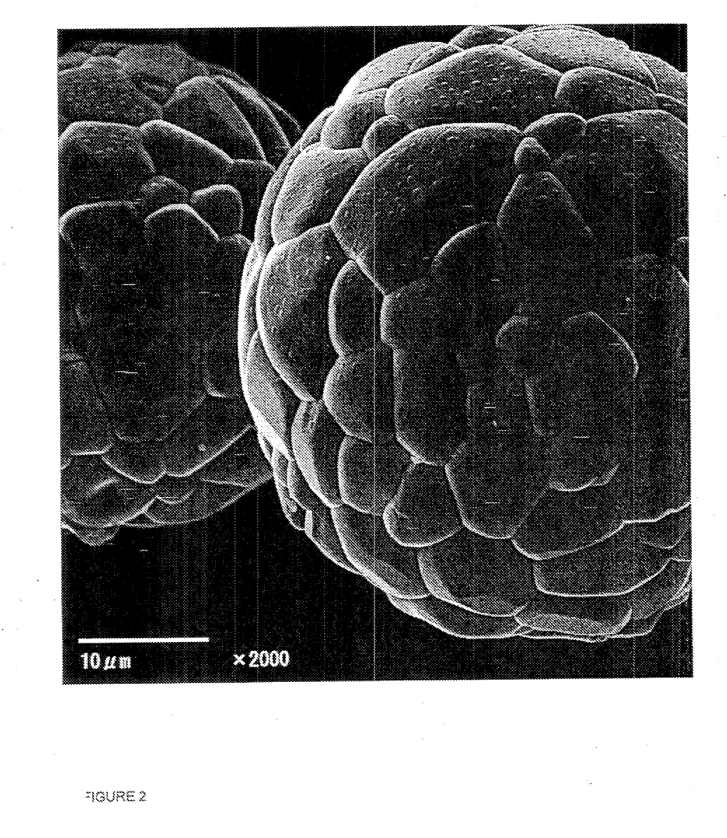

FIG. 3 is a scanning electron microscope photograph of zinc oxide particles of the present disclosure obtained in Example 3.

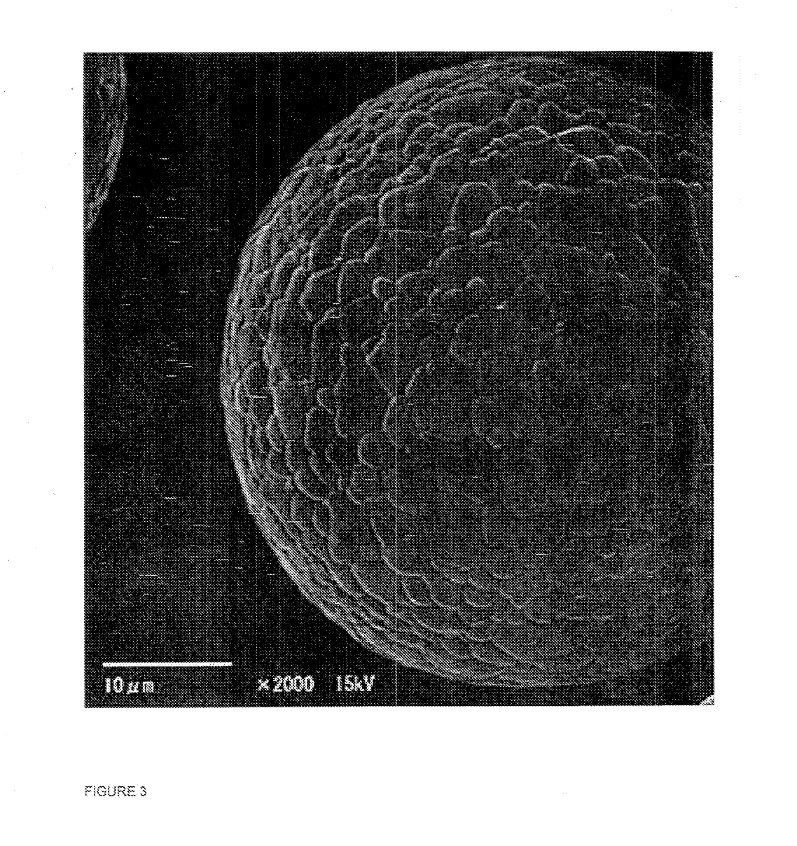

FIG. 4 is a scanning electron microscope photograph of zinc oxide particles of the present disclosure obtained in Example 4.

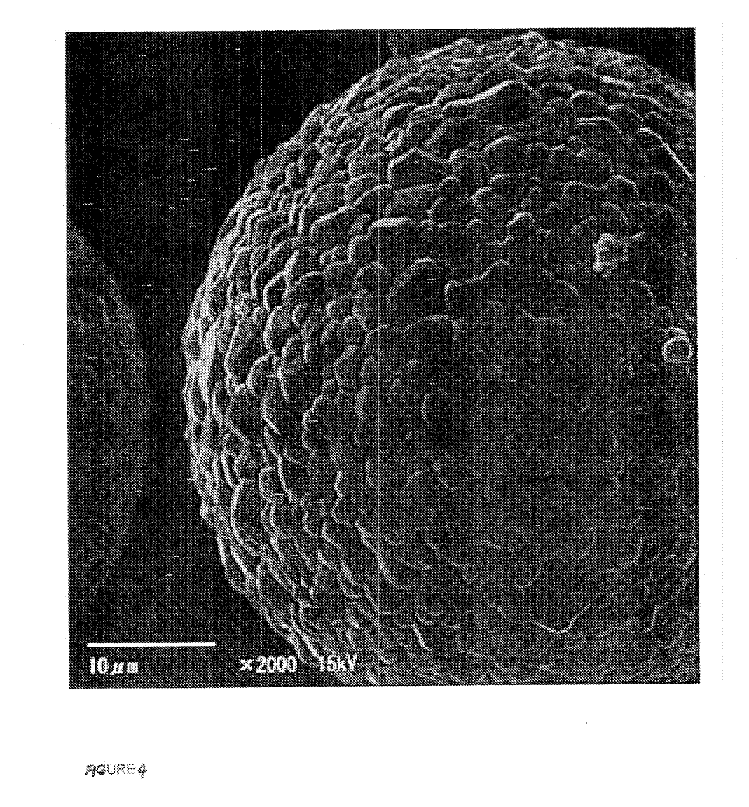

FIG. 5 is a scanning electron microscope photograph of zinc oxide particles of the present disclosure obtained in Example 5.

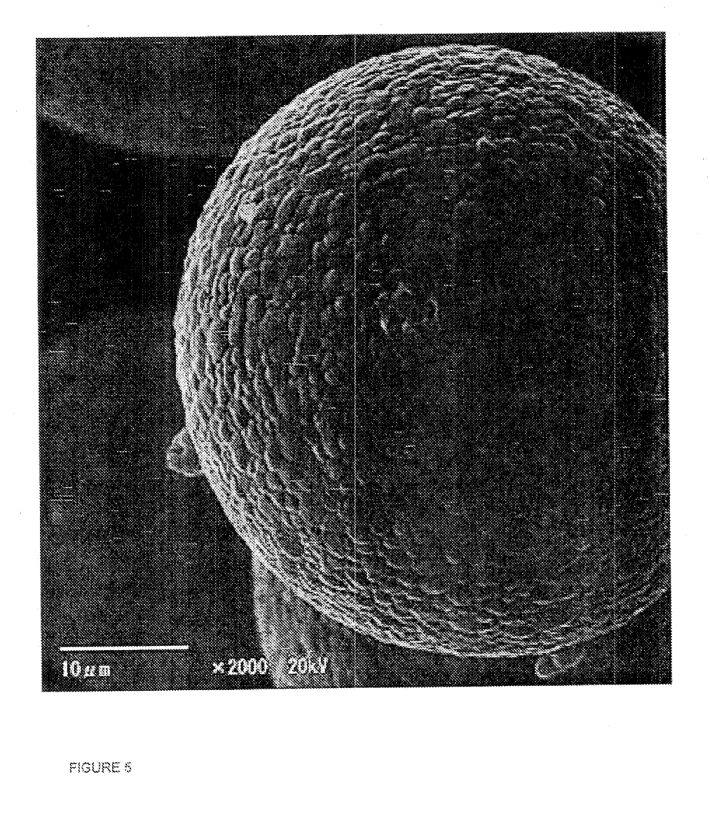

FIG. 6 is a scanning electron microscope photograph of zinc oxide particles of the present disclosure obtained in Example 6.

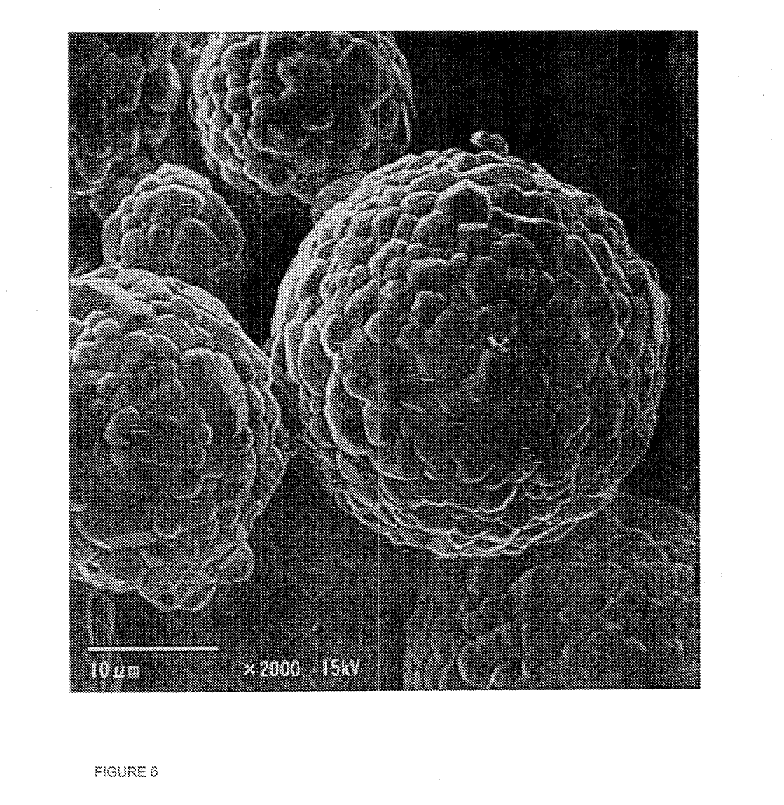

FIG. 7 is a scanning electron microscope photograph of zinc oxide particles of the present disclosure obtained in Example 7.

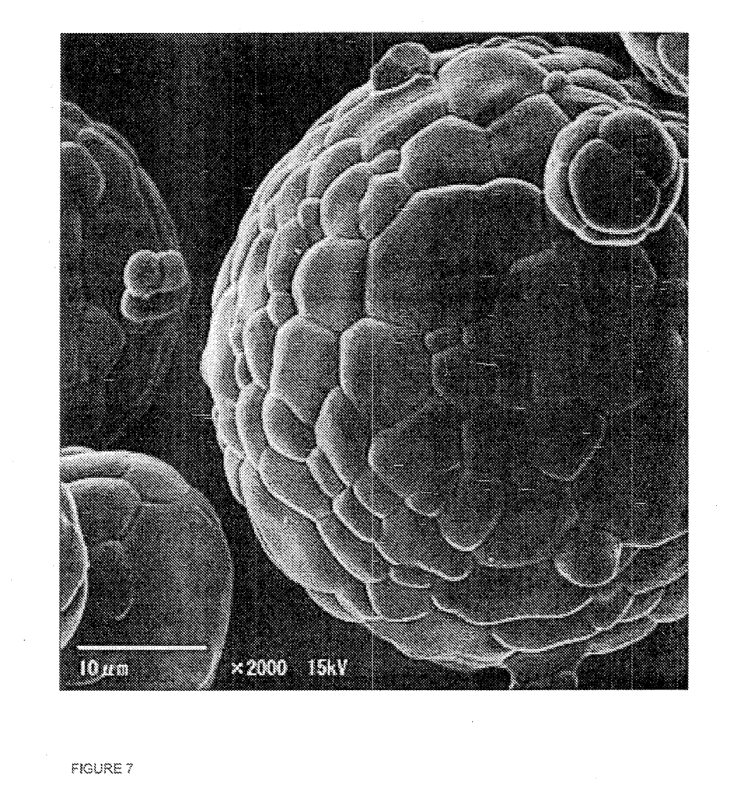

FIG. 8 is a scanning electron microscope photograph of zinc oxide particles of the present disclosure obtained in Example 8.

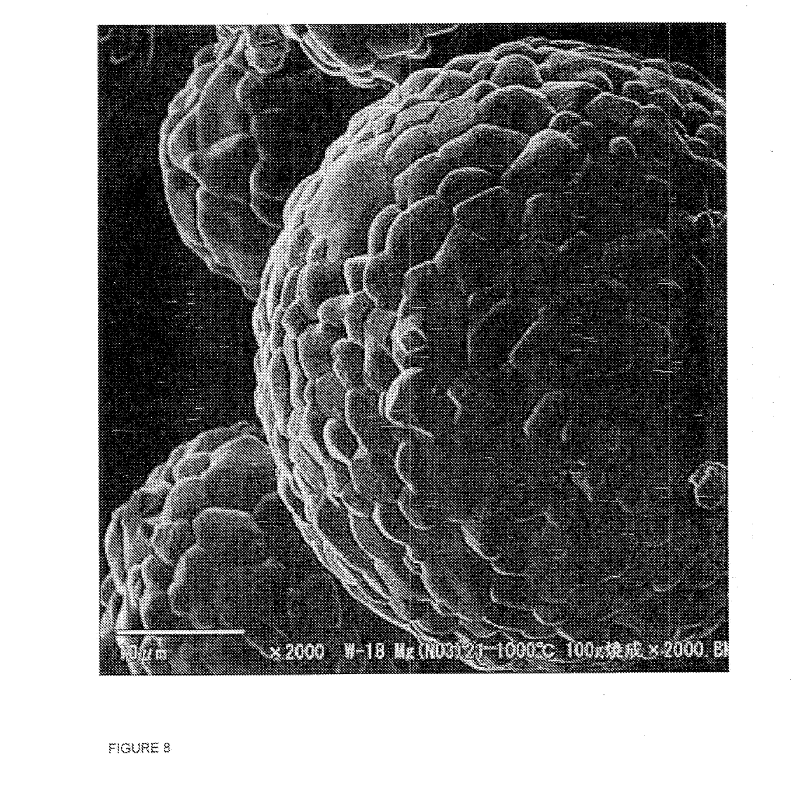

FIG. 9 is a scanning electron microscope photograph of zinc oxide particles of the present disclosure obtained in Example 9.

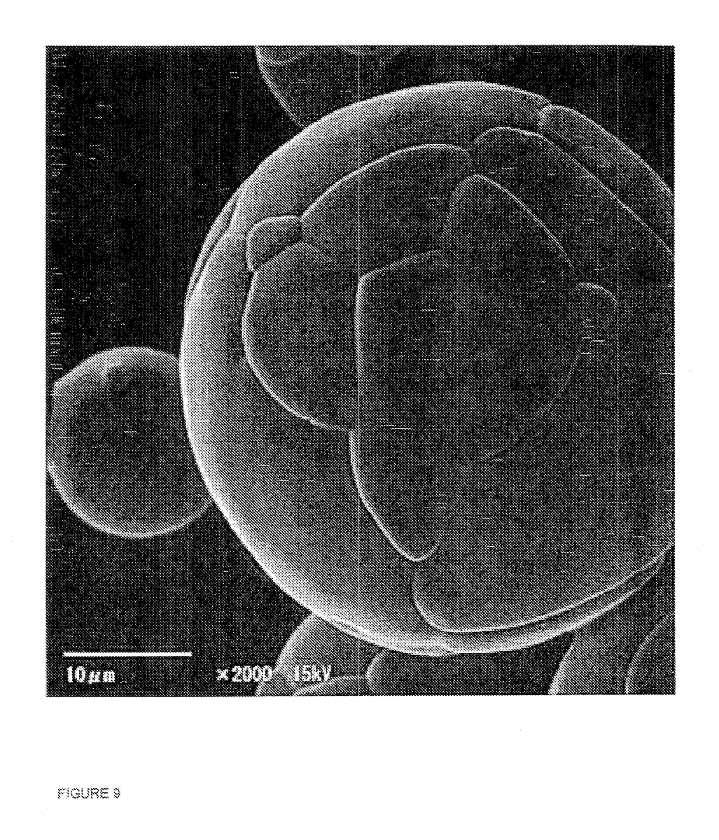

FIG. 10 is a scanning electron microscope photograph of zinc oxide particles of the present disclosure obtained in Example 10.

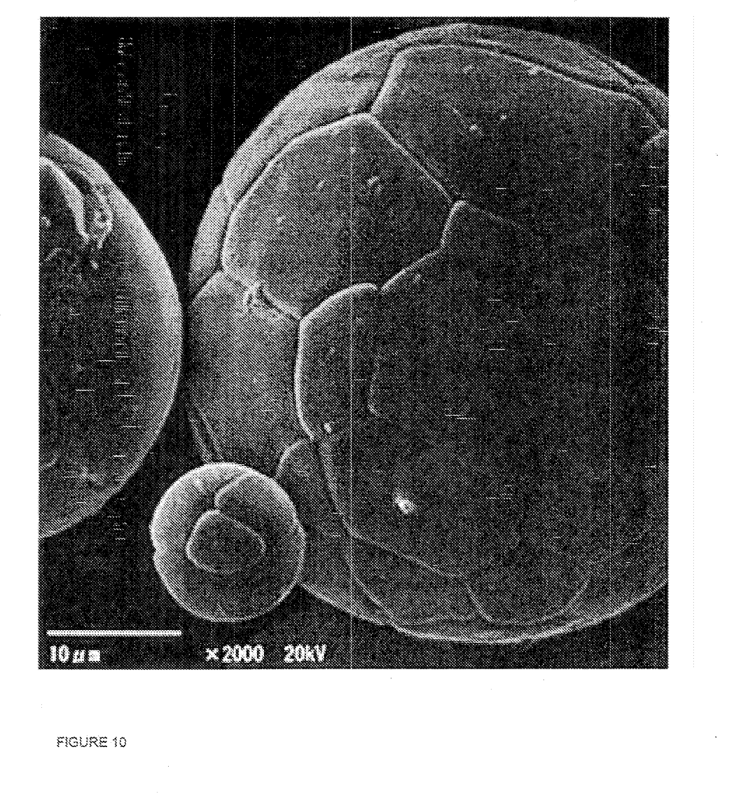

FIG. 11 is a scanning electron microscope photograph of zinc oxide particles of the present disclosure obtained in Example 11.

FIG. 12 is a scanning electron microscope photograph of zinc oxide particles of the present disclosure obtained in Comparative Example 2.

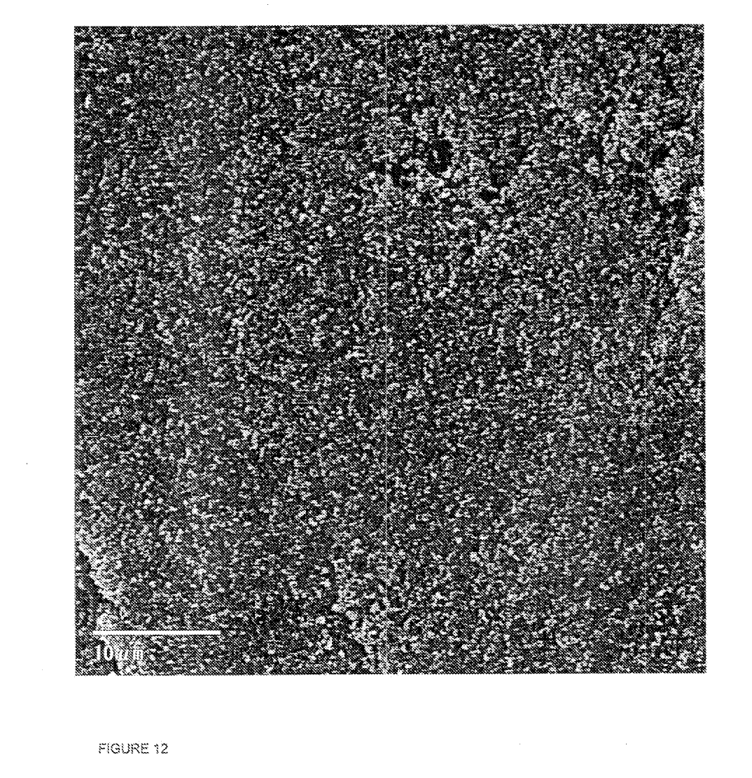

FIG. 13 is a scanning electron microscope photograph of zinc oxide particles of the present disclosure obtained in Comparative Example 3.

FIG. 14 is a scanning electron microscope photograph of zinc oxide particles of the present disclosure obtained in Comparative Example 4.

FIG. 15 is a scanning electron microscope photograph of zinc oxide particles of the present disclosure obtained in Comparative Example 5.

FIG. 16 is a scanning electron microscope photograph of zinc oxide particles of the present disclosure obtained in Comparative Example 6.

FIG. 17 is a scanning electron microscope photograph of zinc oxide particles of the present disclosure obtained in Comparative Example 7.

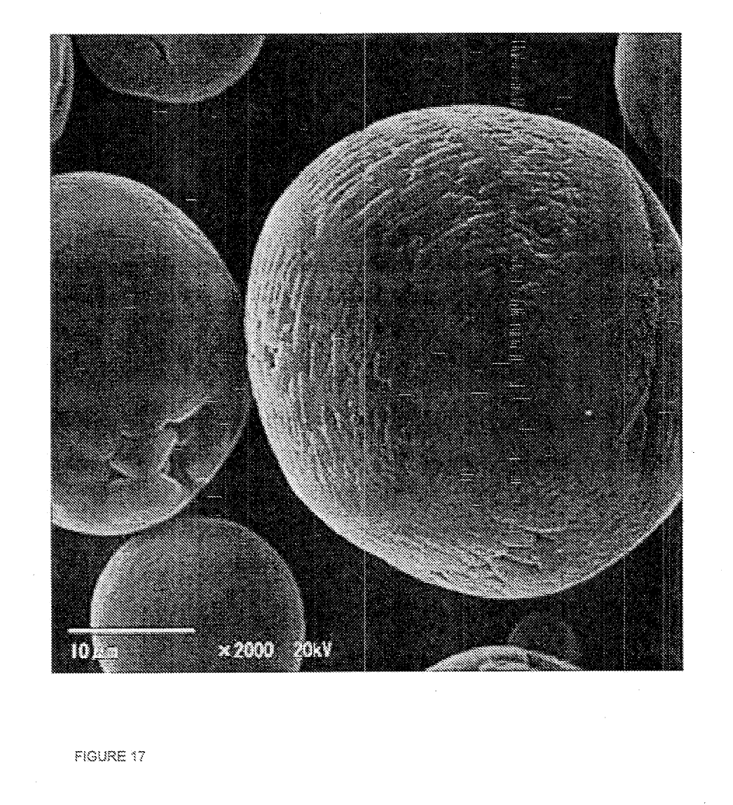

FIG. 18 is a scanning electron microscope photograph of zinc oxide particles of the present disclosure obtained in Comparative Example 8.

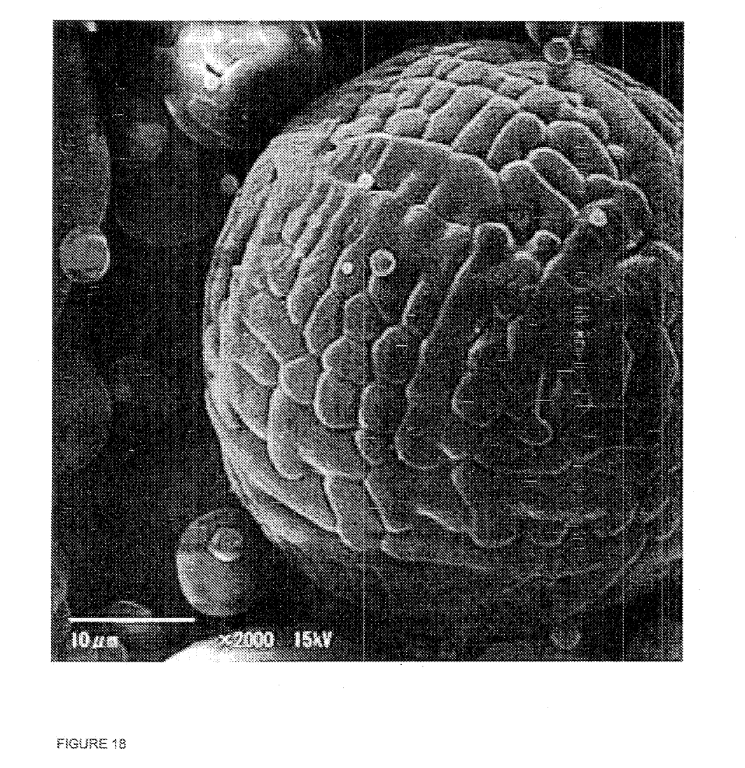

### EMBODIMENTS

In the following, the present disclosure is described in detail.

The present disclosure relates to a zinc oxide particle which can be used for various exoergic materials and has median size (D50) of 17 to 10000 μm and a method for producing it. In the conventional use of the exoergic fillers, there is no example with a zinc oxide having median size (D50) of 17 to 10000 μm and density of 4.0 g/cm³ or more used, and the method for producing such zinc oxide has not been investigated. The present disclosure has been completed by finding that the zinc oxide particle having the specified median size (D50) and density has a more preferred property than conventional zinc oxide.

The zinc oxide particle of the present disclosure has density of 4.0 g/cm³ or more and median size (D50) of 17 to 10000 μm. That is, the zinc oxide particle is characterized by larger particle diameter and higher density than the conventional one. Such zinc oxide particle has not been publicly known and it first produced by the inventors of the present disclosure. In the specification, the median size (D50) is measured by laser diffraction/scattering particle size distribution analyzer LA-750 (manufactured by HORIBA, Ltd.), or by statistical means with the eye. The visual observation can be done by scanning electron microscope JSM-5400 (manufactured by JEOL, Ltd.). The particle has superior property as the exoergic filler derived from the function mentioned above, because the median size (D50) thereof is within the defined range.

The lower limit of the median size is preferably 17 μm, and more preferably 20 μm. The upper limit of the median size (D50) is preferably 10000 μm and more preferably 1000 μm.

The density of the zinc oxide particle of the present disclosure can be measured by Gay-Lussac type pycnometer. The lower limit of the density is more preferably 4.0 g/cm³ and still more preferably 4.5 g/cm³. The high-density zinc oxide particle defined by the above-mentioned range easily produces heat conductivity and has superior property as the exoergic filler because the particle is dense particle with a few hollow portions. If the density is less than 4.0 g/cm3, sufficient exoergic property needed for the present disclosure can not be obtained.

The zinc oxide particle of the present disclosure is preferably spherical. Spherical particles can be closest-packed, so the proportion of the exoergic filler can be increased. Preferably, this results in higher exoergic property. The shape of the particle can be observed by scanning electron microscope JSM-5400 (manufactured by JEOL, Ltd.). The zinc oxide particle preferably has an aspect ratio of 1.0 to 1.5. When the particle is used as an exoergic filler, as the aspect ratio comes close to 1.0, the orientation of the fillers gets less. Therefore, a resin molded article in which fillers are filled uniformly can be obtained by pressure molding from all angles.

The zinc oxide particle of the present disclosure preferably contains at least 97.0 mol % of zinc oxide. That, is, it may contain other metallic atoms than zinc. In this case, the other atoms than zinc are preferably less than 3.0 mol %. The zinc oxide particle in which the content of zinc oxide is high is preferably because heat conductivity is easily generated and it has an excellent property as the exoergic filler.

Generally, it is done to combine small particle, middling particle, and large particle concerning particle diameter for high exoergic property of the exoergic material. The zinc oxide particle of the present disclosure has preferably D90/D10 of 3.0 or less. That is, the ratio of D90 and D10 is preferably small (that is, a coarse particle having extremely large particle diameter is few contained). In this way, the exoergic filler which can be closest-packed is preferably produced because arbitrary-sized particles can be arbitrarily mixed by decreasing the content of coarse particles and making particle size distribution sharper.

D10 and D90 are values determined by measuring the particle size distribution and the measurement is conducted by following the same method as the median size (D50).

As mentioned above, the zinc oxide particle is not particularly limited concerning the producing method thereof, but it can be produced by the following method. This method for producing a zinc oxide particle described after in detail is one aspect of the present disclosure.

The zinc oxide particle of the present disclosure can be obtained by a method for producing a zinc oxide particle, comprising a step (1) of mixing a source of the zinc oxide particle with at least one compound selected from the group consisting organic acids, organic bases, inorganic acids, inorganic bases, and salts thereof to granulate, and a step (2) of baking the granulated particle obtained in the step (1). By using the above-mentioned method, it becomes possible to produce large amounts of zinc oxide particles having median size (D50) of 17 to 10000 μm that show few particle fusion and are baked into particle inside well. The above-mentioned method for producing a zinc oxide particle is suitable method for producing spherical zinc oxide particles.

The method for producing a zinc oxide particle of the present disclosure comprises the step (1) of mixing a source of the zinc oxide particle with at least one compound selected from the group consisting of organic acids, organic bases, inorganic acids, inorganic bases, and salts thereof to granulate. The step (1) is a step of re-pulping a source of the zinc oxide particle in water and mixing with an organic acid, an organic base, an inorganic acid, an inorganic base, or salt thereof to granulate.

In the method for producing a zinc oxide particle of the present disclosure, a source of the zinc oxide particle is used as a raw material. As the source of the zinc oxide particle is not particularly limited provided that it may converted to zinc oxide by baking but includes zinc oxide, zinc nitrate, zinc sulfate, zinc carbonate, zinc acetate, and so on. As the above-mentioned source of the zinc oxide particle, zinc oxide is especially preferred. The source of the zinc oxide particle preferably has median size (D50) of 0.01 to 1.0 μm. The median size (D50) of the source of the zinc oxide particle is measured by laser diffraction/scattering particle size distribution analyzer LA-750 (manufactured by HORIBA, Ltd.) or dynamic light scattering particle size distribution analyzer ELS-Z2 (manufactured by OTSUKA ELECTRONICS, Ltd.).

The zinc oxide which is used as a raw material is not particularly limited, but the zinc oxide produced in French Method, American Method and other common methods can be used. Particularly, zinc oxide which is produced in French Method is preferably used because the zinc oxide has few impurities.

The organic acid, organic base, inorganic acid, and inorganic base include, for example, acetic acid, citric acid, propionic acid, butyric acid, lactic acid, oxalic acid, stearic acid, nitric acid, sulfuric acid, hydrogen peroxide, hydroxide ion, ammonia, pyridine, piperazine, imidazole and so on. The salt thereof contains, for example, ammonium salt, zinc salt, magnesium salt, copper salt, sodium salt, potassium salt, lithium salt, amine salt, and cesium salt. More specifically, ammonium polycarboxylate, zinc acetate, magnesium acetate, copper acetate, sodium acetate, potassium acetate, lithium acetate, lithium stearate, zinc nitrate, lithium nitrate, magnesium nitrate, copper nitrate, zinc sulfate, lithium hydroxide, sodium hydroxide, potassium hydroxide and cesium hydroxide may be used.

Especially, lithium salt is preferred because it is able to make the surface of the baked particle smooth and adjust the particle shape.

The mixing amount of the organic acid, organic base, inorganic acid, inorganic base and salt thereof depends on a component to be mixed but is preferably 0.3 to 8.0 weight parts relative to the weight of the source of the zinc oxide particle because zinc oxides are baked densely on baking process.

When acetic acid is used as the organic acid, organic base, inorganic acid, inorganic base, or salt thereof, the mixing amount of the acetic acid is preferably 0.6 to 2.0 weight parts relative to the weight of the source of the zinc oxide particle because zinc oxides are baked densely on baking process.

However, the organic acid, organic base, inorganic acid, inorganic base, or salt thereof should not be one containing a halogen component such as ammonium bromide and hydrochloric acid. When the compound containing a halogen component is mixed, it is hard to obtain a zinc oxide particle being spherical and having median size (D50) of 17 to 10000 μm.

The granulation in the step (1) is not particularly limited about the method thereof, but it can be conducted by a method comprising dispersing the source of the zinc oxide particle and the organic acid, organic base, inorganic acid, inorganic base, or salt thereof not containing a halogen into water to prepare a slurry and spray drying and other methods. In addition, there is a method comprising adding an aqueous solution of the organic acid, organic base, inorganic acid, inorganic base, or salt thereof not containing a halogen to the source of the zinc oxide particle and mixing them with spartan granulator, spartan mixer, henschel mixer, or marumerizer to granulate and other methods.

In the step (1), if the case of using the slurry, a dispersant may be used. It is preferred to use a fatty acid salt as the organic acid salt because the organic acid salt itself has a dispersant function so the slurry can be obtained easily. Compounds that can be used suitably as dispersant are not particularly limited but include ammonium polycarboxylate salt (POIZ532A manufactured by KAO Corporation, Ltd.).

A method for preparing the slurry is not particularly limited but includes, for example, a method comprising adding the above-mentioned components to water and dispersing at 18 to 30° C. for 10 to 30 minutes to obtain homogeneous slurry having the source of the zinc oxide particle content of 100 to 1500 g/L.

The method of spray drying is not particularly limited but includes, for example, a method comprising spraying the slurry into flowing air at about 150 to 300° C. by two-fluid nozzle or rotary disc to produce granulated particles having particle diameter of about 20 to 100 μm. On this occasion, it is preferred to adjust the slurry concentration within the range of 50 to 3500 cps of the viscosity of the slurry. The viscosity of the slurry is measured by using B-type viscometer (manufactured by TOKYO KEIKI, Ltd.) with 60 rpm share. In this flowing air, the granulated particles being dried are trapped by a filter with submicron order (bag filter). If the slurry viscosity, drying temperature, and flowing speed are without the desired range, the granulated particles becomes hollow or takes depressed shape.

The zinc oxide particles can be obtained by baking the particles thus obtained. The baking conditions are not particularly limited but it is preferred to conduct the baking under the condition that the baking temperature is 700 to 1500° C., the baking time is 1 to 3 hours and the baking is static baking. The static baking can be conducted in a pot made of mullite or mullite/cordierite. The baking is more preferably conducted at 1000 to 1200° C. By baking in the above-mentioned method, zinc oxide particles showing few particle fusion and being baked densely into the particle inside can be obtained.

The baking at less than 700° C. is not preferred because the particle may not be baked sufficiently into the particle inside. If exceeding 1500° C., it is not preferred because the particle fusion proceeds.

The zinc oxide particles obtained by the above method have a sharp particle size distribution, but the zinc oxide particles may be classified using a sieve if sharper particle size distribution is required or in order to remove a few coarse particles contained therein. The classification using a sieve includes wet classification and dry classification.

Even if the particle size of the source of the zinc oxide particle as a raw material varies in the method, the same zinc oxide particles as mentioned above can be obtained by adjusting the amount of the organic acid, organic base, inorganic acid, inorganic base, and salt thereof not containing a halogen, the amount of the dispersant, the slurry concentration, and the baking temperature, suitably. In the case of spray drying, it is able to control the particle size by varying the slurry supplied amount in the case of two-fluid nozzle, and by varying the number of rotations in the case of rotary disc. By raising the baking temperature, the density of the baked zinc oxide particle can be increased.

The zinc oxide particles obtained by the above method have the following advantages over the conventional zinc oxide particles;
1. It is possible to increase the particle size and make the particle spherical.
2. It is not needed to use a flux that may damage an oven in the production method.
3. The particle can be filled in a resin in the large amount.
4. When the particles are filled up densely in a resin, extremely good exoergic property can be showed.
   This effect is derived from the fact that the particle diameter is extremely larger than the conventional zinc oxide particle, the particle shape is controlled to have spherical shape, and crystallinity and density are high.

The use of the zinc oxide particle of the present disclosure is not particularly limited but the particles can be used as an exoergic filler, for example. This exoergic filler is one aspect of the present invention.

When the zinc oxide particle is used as exoergic filler, the particles can be used in the form of a resin composition obtained by mixing with a resin. In this case, the resin may be a thermoplastic resin or a thermosetting resin and includes epoxy resins, phenol resins, polyphenylene sulfide resins (PPS), polyester resins, polyamides, polyimides, polystyrenes, polyethylenes, polypropylenes, polyvinyl chloride, polyvinylidene chloride, fluorine resins, polymethyl methacrylate, ethylene/ethyl acrylate copolymer resin (EEA), polycarbonates, polyurethanes, polyacetals, polyphenylene ethers, polyetherimides, acrylonitrile-butadiene-styrene copolymer resin (ABS), epoxides, phenols, liquid crystal resins (LCP), silicone resins, acrylic resins and other resins.

The exoergic resin composition of the present disclosure may be (1) a resin composition for thermal molding obtained by kneading a thermoplastic resin and the zinc oxide particle in melting condition, (2) a resin composition obtained by kneading a thermosetting resin and the zinc oxide particle followed by thermosetting, (3) a resin composition for paint obtained by dispersing the zinc oxide particle in a resin solution or dispersion liquid, or other resin composition.

The addition amount of the zinc oxide particle in the exoergic resin composition of the present disclosure can be arbitrarily determined according to the intended performance of the resin composition such as exoergic property, hardness and so on. In order to express the exoergic property of the zinc oxide particle sufficiently, the addition amount of the zinc oxide particle is preferably 60 volume % or more, more preferably 68 volume % or more relative to the total solid matter of the resin composition.

When the exoergic resin composition of the present disclosure is a resin composition for thermal molding, the resin component may be selected in accordance to the use. For example, when the resin composition is placed between the heat source and the exoergic plate to make them stick together, resins having high adhesion property and low hardness such as silicone resins and acrylic resins can be selected.

When the exoergic resin composition of the present disclosure is a resin composition for paint, the resin may be a hardenable one or a nonhardenable one. The coating composition may be a solvent type one containing organic solvents or an aqueous type one containing a resin dissolved or dispersed in water.

When the zinc oxide particle is used as an exoergic filler, the particle may be used as an exoergic grease obtained by mixing with a base oil which contains a mineral oil or a synthetic oil. When the particles are used as this exoergic grease, as the synthetic oil, α-olefins, diesters, polyol esters, trimellitic esters, polyphenyl ethers, alkylphenyl ethers and so on can be used. In addition, the particles can be used as an exoergic grease obtained by mixing with silicone oils.

When the zinc oxide particle of the present disclosure is used as an exoergic filler, the particle may be used in combination with other components. The other components which may be used together, include other exoergic fillers than zinc oxide such as metal oxides including magnesium oxide, titanium oxide and aluminum oxide, aluminum nitride, boron nitride, silicon carbide, silicon nitride, titanium nitride, metallic silicon, and diamond, resins and surfactants.

The zinc oxide particle of the present disclosure can obtain better exoergic property by combining other zinc oxide particles having smaller median size (D50) and other exoergic filler. The zinc oxide particle having smaller median size (D50) to be used in combination preferably takes spherical shape, needle shape, or plate-like shape.

The zinc oxide particle of the present disclosure can be used in the fields such as rubber accelerators, pigments for coating compositions and inks, such electronic components as ferrite and varistor, medicinal products and cosmetics in addition to the exoergic filler.

### EXAMPLES

Hereinafter, the present disclosure will be described in more detail by way of examples, but the present disclosure is not limited to these examples.

### Examples

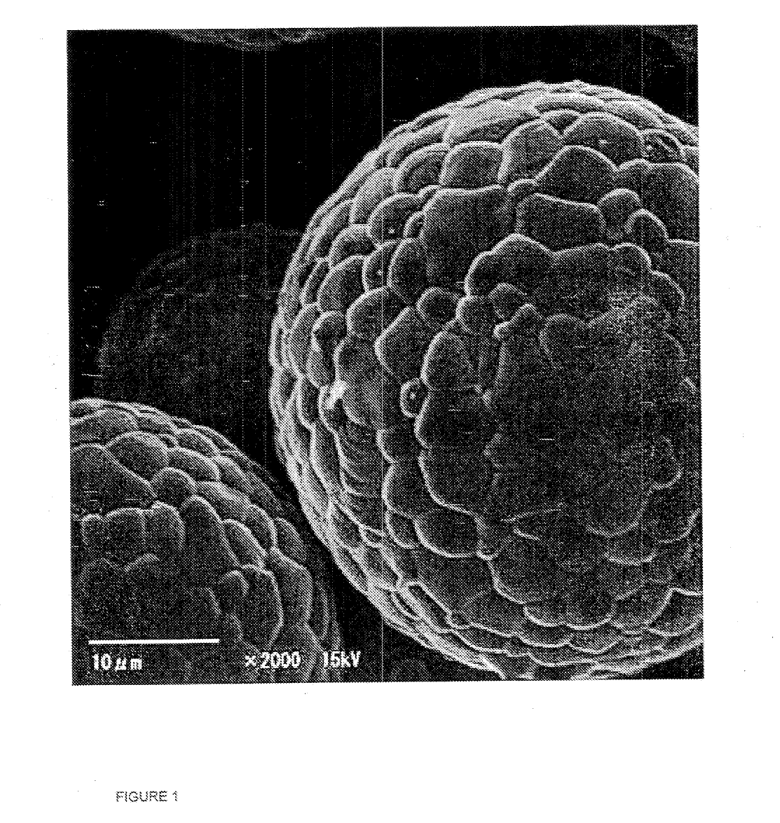

ZINC OXIDE SUPERFINE (manufactured by Sakai Chemical Industry, Ltd., median size (D50) 0.2 μm) 600 g was re-pulped into water, dispersant (manufactured by KAO, Ltd., POIZ532A) 3.5 weight parts relative to the ZINC OXIDE SUPERFINE were added to the aqueous solution, and acetic acid 0.61 weight part was added to prepare a slurry with concentration of 600 g/L. Next, this slurry was spray dried by using SOLVENT TYPE SPRAY DRYER (manufactured by Sakamoto Giken, Ltd.) to obtain granulated particles. These particles were put in a pot made of mullite or mullite/cordierite and static baked at 1200° C. for 3 hours. After cooling and dispersing into water 1.0 L, this slurry was screened through 200 mesh (opening of screen 75 μm). The slurry passing through the mesh was filtered and dried to obtain zinc oxide particles showing few particle fusion, being baked densely into the particle inside, being spherical and having a median size (D50) of 28.5 μm. The size and shape of the obtained zinc oxide particle were observed by Scanning Electron Microscope JSM-5400 (manufactured by JEOL, Ltd.). The obtained electron microscope photograph was shown in FIG. 1.

### Examples 2 to 10

The zinc oxide particles were obtained by following the same procedure as that of Example 1 except that the organic acid, organic base, inorganic acid, inorganic base, and the salts thereof not containing a halogen to be added, the addition amount thereof, and treatment conditions were changed as shown in Tables 1 and 2.

### Example 11

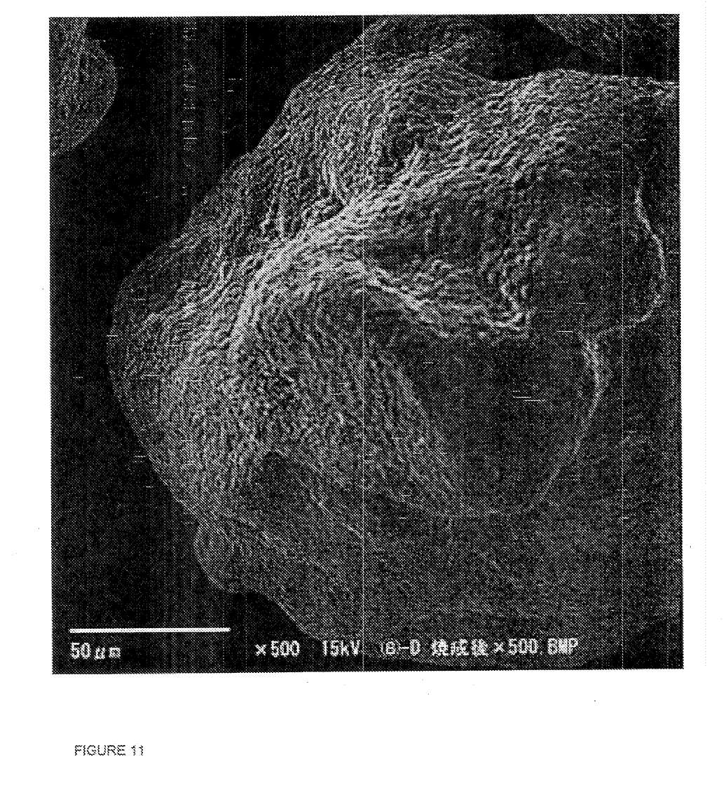

ZINC OXIDE SUPERFINE (manufactured by Sakai Chemical Industry, Ltd., median size (D50) 0.3 μm) 10 kg was charged into the cylindrical container inside of Spartan granulator RMOJ-15HN (manufactured by DALTON.CO, Ltd.). While adding an aqueous solution of acetic acid 0.61 weight part and water 1.8 L, the mixture was mixed by setting the number of rotations of chopper and mixing arm at 1320 rpm for 240 seconds, and the obtained mixture was mixed at 2410 rpm for 340 seconds after adding the aqueous solution to obtain granulated particles. These particles were put into a pot made of mullite or mullite/cordierite and static baked at 1000° C. for 3 hours. The size and shape of the obtained zinc oxide particle were observed by Scanning Electron Microscope (JSM-5400 manufactured by JEOL, Ltd.), being found that particles baked densely into the particle inside with the particle diameter of 200 to 300 μm were obtained. The obtained electron microscope photograph was shown in FIG. 11.

The measurements in Tables 1 to 4 were done by the following method.

### (Median Size (D50), D10, D90)

Zinc oxide particles 1.0 g weighed were dispersed into 0.025 weight % sodium hexametaphosphate aqueous solution 100 mL. The obtained dispersion liquid was charged into measurement bath of laser diffraction/scattering particle size distribution analyzer LA-750 (manufactured by HORIBA, Ltd.) filled with 0.025 weight % sodium hexametaphosphate aqueous solution and measured under the conditions that circulation speed:15, ultrasonic wave strength:7, and ultrasonic wave time:3 minutes. Median size (D50), D10 and D90 were decided while setting relative refractive index at 1.5 because refractive index of zinc oxide was 1.9 to 2.0 and that of water was 1.3 at room temperature.

### (Aspect Ratio)

In the 100 particles in the electron microscope photograph taken by Scanning Electron Microscope JSM-5400 (manufactured by JEOL, Ltd.), long length and short length were measured by a scale and aspect ratio was decided by dividing long length by short length. The aspect ratio was decided by averaging the aspect ratios of the 100 particles.

### (Density)

Weight a (g) of 100 mL Gay-Lussac type pycnometer that had washed and dried was weighed to the digit of 0.1 mg, distillated water was charged to the gauge line, and the weight b (g) of the pycnometer was weighed to the digit of 0.1 mg. Next, after the Gay-Lussac type specific gravity pycnometer was dried, sample 5 g was charged and weight c (g) of the sample was calculated by weighing the pycnometer. Distillated water was charged until the sample was covered and air contained in the distillated water was removed in vacuum desiccators. Distillated water was charged to the gauge line and the weight d (g) of the pycnometer was weighed to the digit of 0.1 mg to calculate the density according to the following formula.

Density (g/cm3)=c/((b−a)+c−(d−a))

### (Filling Rate of Filler)

(i) EEA resin (REXPEARL A1150 manufactured by Japan Polyethylene Corporation, Ltd.) and zinc oxide particles of Examples 1, 9, and 11, (ii) EEA resin not containing the filler of Comparative Example 1, (iii) EEA resin and zinc oxide particles of Comparative Examples 2 and 4, and (iv) EEA resin and alumina (manufactured by SHOWA DENKO K. K.) of Comparative Examples 7 and 8 were mixed as-shown in Table 4. In other Examples and Comparative Examples, components were mixed by following the same procedure as mentioned above. The filling rate of filler (volume %) was calculated supposing that specific gravity of the EEA resin was 0.945, specific gravity of the zinc oxide particle was 5.55, and specific gravity of alumina particle was 3.80. Having set weight of filler as a (g), specific gravity of the filler as A, weight of the EEA resin as b (g), and specific gravity of the EEA resin as B, filling rate of the filler (volume %) was calculated according to the following formula.

Filling rate of filler (volume %)=(a/A)/((a/A)+(b/B))×100

### (Heat Conductivity)

(i) EEA resin and zinc oxide particles of Examples 1, 2, 3, 4, 6, 9, and 11, (ii) EEA resin not containing the filler of Comparative Example 1, (iii) EEA resin and zinc oxide particles of Comparative Examples 2, 4, 5, and 6, and(iv) EEA resin and alumina of Comparative Examples 7 and 8 were heated and mixed in LABO PLASTMILL (manufactured by TOYO SEIKI SEISAKU-SYO, Ltd.) at the number of rotations of 40 rpm and 150° C. for 10 minutes in the proportions as shown in Tables 1 to 4.

The mixture of the filler and the resin were taken out and put on a center of a stainless-steel casting mold with 2 mm thickness (150 mm×200 mm). It was nipped with two stainless-steel plates (200 mm×300 mm) from above and below and put on specimen support of MINI TEST PRESS-10 (manufactured by TOYO SEIKI SEISAKU-SYO, Ltd.) followed by pressuring at 150° C. and 0.5 MPa for 5 minutes and then pressuring at 150° C. and 25 MPa for 3 minutes.

Next, the casting mold was put on the specimen support of Steam Press Machine (manufactured by Gonno Yuatsuki Seisakusyo, Ltd.) and then it was cooled at 25MPa with running coolant water for 5 minutes to obtain a sheet of resin composition after pressuring to 25 MPa with passing steam and heating.

Next, the sheet was cut out to be a molded article of 55 mmφ and 2.0 mm thickness by punch and the heat conductivity was measured following setting on the specimen support of AUTOA HC-110 (manufactured by EKO Instruments Co., Ltd, the method with heat flow meter). AUTOA HC-110 was pre-compensated by using Pyrex standard plate with 6.45 mm thickness before measurement. Heat conductivity (W/m·K) when reached a condition of thermal equilibrium at 25° C. was measured by measuring while a high temperature heater was set at 35° C. and low temperature heater was set at 15° C. The results were shown in Tables 1 to 4.

### Comparative Example 1

Heat conductivity of the similar molded article of EEA resin not containing the filler was measured by following the same procedure as that of the above Examples. The results were shown in Tables 3 and 4.

### Comparative Example 2

Heat conductivity was measured by following the same procedure as that of the above Examples concerning ZINC OXIDE SUPERFINE (manufactured by Sakai Chemical Industry, Ltd., median size (D50) 0.2 μm). The results were shown in Tables 3 and 4.

### Comparative Example 3

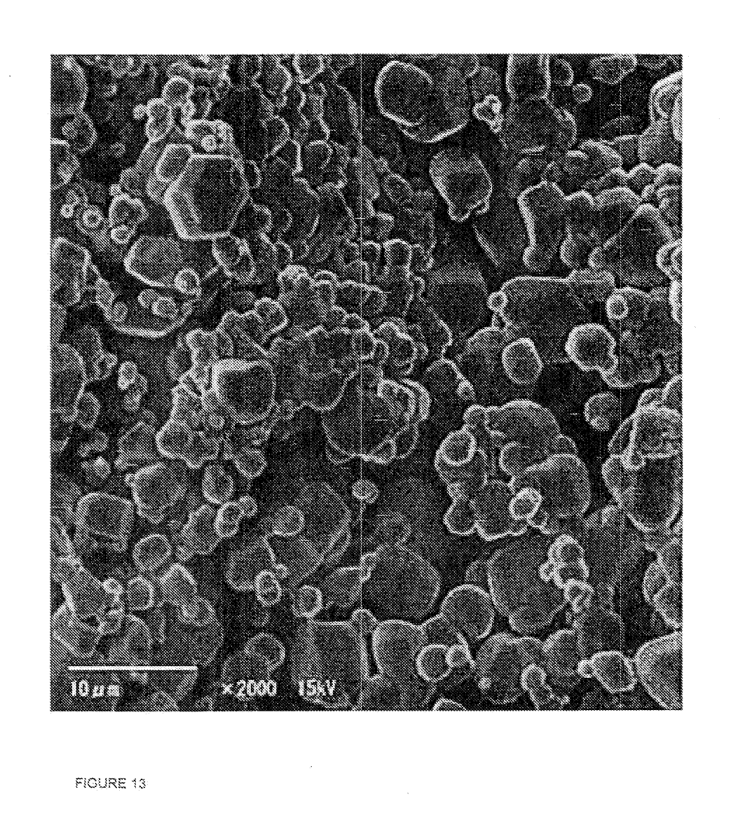

ZINC OXIDE SUPERFINE (manufactured by Sakai Chemical Industry, Ltd., median size (D50) 0.2 μm) 600 g was re-pulped into water to prepare a slurry with concentration of 1200 g/L. Next, this slurry was spray dried by using SOLVENT TYPE SPRAY DRYER (manufactured by Sakamoto Giken, Ltd.) to obtain granulated particles. These particles were put in a pot made of mullite or mullite/cordierite and static baked at 1000° C. for 3 hours. After cooling and dispersing into water 1.0 L, this slurry was screened through 200 mesh (opening of screen 75 μm). The slurry passing through the mesh was filtered and dried to obtain zinc oxide particles having median size (D50) of 13.3 μm. The size and shape of the obtained zinc oxide particle were observed by Scanning Electron Microscope JSM-5400 (manufactured by JEOL, Ltd.). The obtained electron microscope photograph was shown in FIG. 13.

### Comparative Example 4

ZINC OXIDE NO. 1 (manufactured by Sakai Chemical Industry, Ltd., median size (D50) 0.6 μm) 1200 g and ammonium bromide 12 g were mixed for 30 seconds, and the obtained mixed powder was charged in a pot made of mullite or mullite/cordierite followed by baking at 1150° C. for 3 hours.

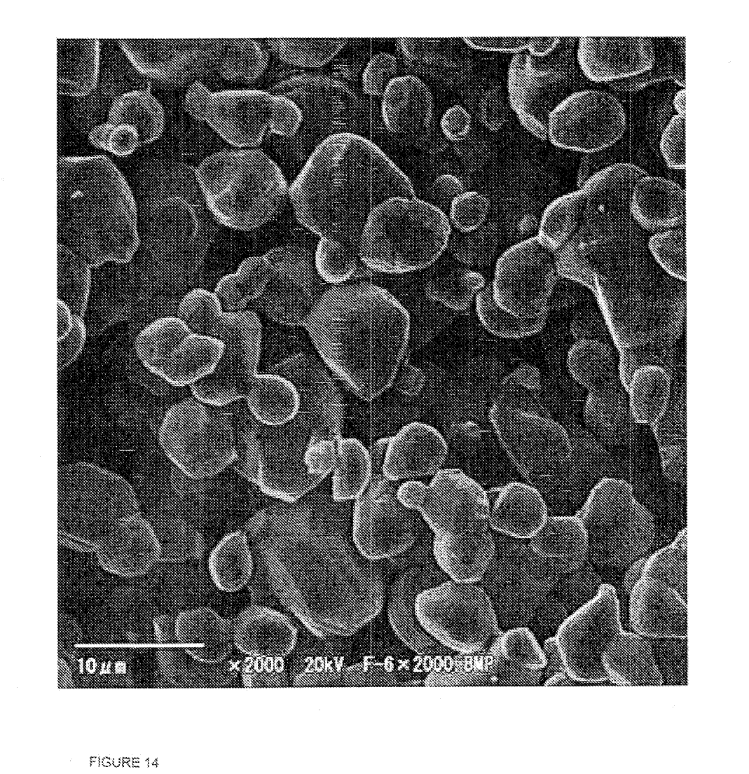

After cooling and dispersing into water 3.5 L, this slurry was screened through 200 mesh (opening of screen 75 μm). The slurry passing through the mesh was filtered and dried to obtain pseudosphere-shaped zinc oxide particles having median size (D50) of 10.2 μm. The size and shape of the obtained zinc oxide particle were observed by Scanning Electron Microscope JSM-5400 (manufactured by JEOL, Ltd.). The obtained electron microscope photograph was shown in FIG. 14. Heat conductivity was measured by following the same procedure as that of the above Examples. The results were shown in Tables 3 and 4.

### Comparative Example 5

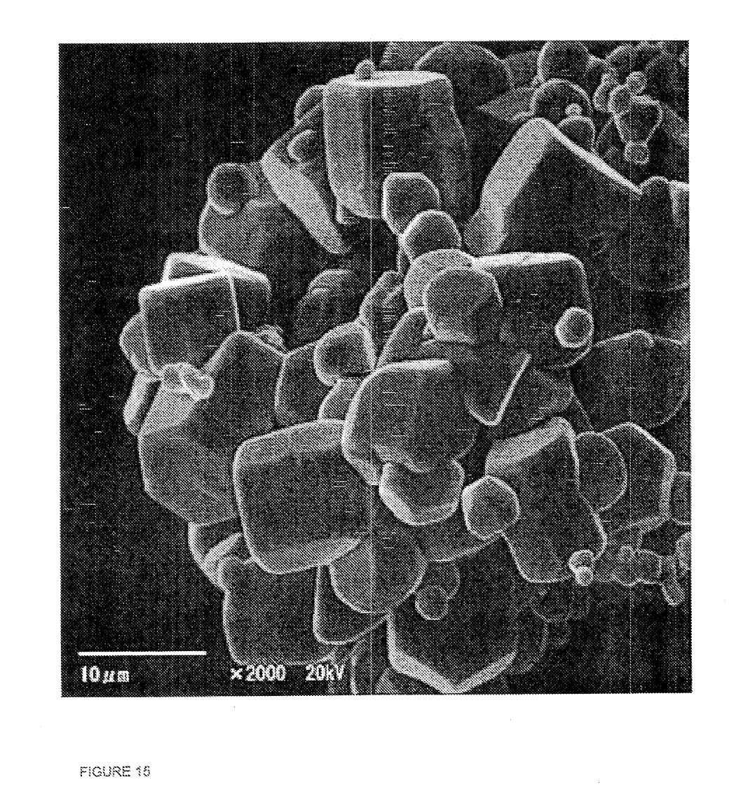

ZINC OXIDE SUPERFINE (manufactured by Sakai Chemical Industry, Ltd., median size (D50) 0.2 μm) 600 g was re-pulped into water, dispersant (manufactured by KAO, Ltd., POIZ532A) 3.5 weight parts relative to the ZINC OXIDE SUPERFINE were added to the aqueous solution, and ammonium bromide 1.00 weight parts were added to prepare a slurry with concentration of 840 g/L. Next, this slurry was spray dried by using SOLVENT TYPE SPRAY DRYER. (manufactured by Sakamoto Giken, Ltd.) to obtain granulated particles. These particles were put in a pot made of mullite or mullite/cordierite and static baked at 1000° C. for 3 hours. After cooling and dispersing into water 1.0 L, this slurry was screened through 200 mesh (opening of screen 75 μm). The slurry passing through the mesh was filtered and dried to obtain zinc oxide particles having median size (D50) of 14.4 μm. The size and shape of the obtained zinc oxide particle were observed by Scanning Electron Microscope JSM-5400 (manufactured by JEOL, Ltd.). The obtained electron microscope photograph was shown in FIG. 15. Heat conductivity was measured by following the same procedure as that of the above Examples. The results were shown in Tables 3 and 4.

### Comparative Example 6

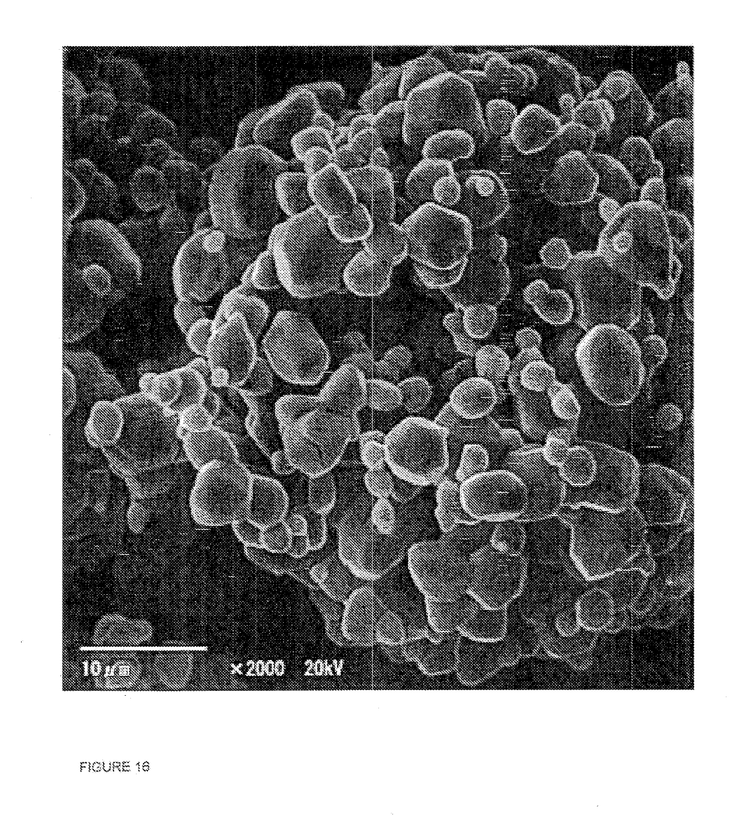

ZINC OXIDE SUPERFINE (manufactured by Sakai Chemical Industry, Ltd., median size (D50) 0.2 μm) 600 g was re-pulped into water, dispersant (manufactured by KAO, Ltd., POIZ532A) 3.5 weight parts relative to the ZINC OXIDE SUPERFINE were added to the aqueous solution, and hydrochloric acid 0.37 weight part was added to prepare a slurry with concentration of 580 g/L. Next, this slurry was spray dried by using SOLVENT TYPE SPRAY DRYER (manufactured by Sakamoto Giken, Ltd.) to obtain granulated particles. These particles were put in a pot made of mullite or mullite/cordierite and static baked at 1000° C. for 3 hours. After cooling and dispersing into water 1.0 L, this slurry was screened through 200 mesh (opening of screen 75 μm). The slurry passing through the mesh was filtered and dried to obtain zinc oxide particles having median size (D50) of 13.2 μm. The size and shape of the obtained zinc oxide particle were observed by Scanning Electron Microscope JSM-5400 (manufactured by JEOL, Ltd.). The obtained electron microscope photograph was shown in FIG. 16. Heat conductivity was measured by following the same procedure as that of the above Examples. The results were shown in Tables 3 and 4.

TABLE 1

| Example | 1 | 2 | 3 | 4 | 5 | 6 | 7 | 8 |
|---|---|---|---|---|---|---|---|---|
| Added reagent | Acetic | Zinc nitrate | Oxalic | Citric | Hydrogen | Nitric | Magnesium | Magnesium |
| (component \textcircled{1}/ | acid/— | hexahydrate/— | acid/— | acid/— | peroxide/— | acid/— | acetate | nitrate |
| component \textcircled{2}) | | | | | | | tetrahydrate/— | hexahydrate/— |
| Addition amount | 0.61 weight | 3.04 weight | 0.97 weight | 1.98 weight | 0.35 weight | 0.64 weight | 2.21 weight | 2.70 weight |
| of component \textcircled{1} | part relative | parts relative | part relative | parts relative | part relative | part relative | parts relative | parts relative |
| | to zinc oxide | to zinc oxide | to zinc oxide | to zinc oxide | to zinc oxide | to zinc oxide | to zinc oxide | to zinc oxide |
| Addition amount | | | | | | | | |
| of component \textcircled{2} | | | | | | | | |
| Addition amount | 3.5 weight | 3.0 weight | 3.5 weight | 3.5 weight | 3.5 weight | | 3.5 weight | 3.5 weight |
| of dispersant | parts relative | parts relative | parts relative | parts relative | parts relative | | parts relative | parts relative |
| (POIZ 532A) | to zinc oxide | to zinc oxide | to zinc oxide | to zinc oxide | to zinc oxide | | to zinc oxide | to zinc oxide |
| Concentration | 600 | 480 | 1330 | 790 | 1000 | 180 | 560 | 500 |
| of slurry (g/l) | | | | | | | | |
| Baking | 1200° C./ | 1200° C./ | 1000° C./ | 1000° C./ | 1000° C./ | 1000° C./ | 1200° C./ | 1200° C./ |
| temperature/ | 3 Hr | 3 Hr | 3 Hr | 3 Hr | 3 Hr | 3 Hr | 3 Hr | 3 Hr |
| baking time | | | | | | | | |
| Median size | 28.5 | 35.2 | 34.3 | 32.4 | 31.1 | 22.6 | 30.4 | 31.3 |
| D50 (μm) | | | | | | | | |
| D10 (μm) | 17.7 | 21.9 | 21.2 | 20.7 | 1.86 | 14.6 | 19.2 | 18.9 |
| D90 (μm) | 47.4 | 57.1 | 56.0 | 51.5 | 51.0 | 36.7 | 49.1 | 49.8 |
| D90/D10 | 2.7 | 2.6 | 2.6 | 2.5 | 2.7 | 2.5 | 2.6 | 2.6 |
| Aspect ratio | 1.02 | 1.05 | 1.08 | 1.08 | 1.07 | 1.05 | 1.09 | 1.08 |
| Density (g/cm³) | 4.78 | 4.75 | 4.64 | 4.58 | 4.61 | 4.65 | 6.20 | 5.18 |
| Filler filling rate | 62.8 | 62.9 | 62.9 | 62.9 | | 62.9 | | |
| \textcircled{1} (volume %) | | | | | | | | |
| Heat conductivity | 3.3 | 3.1 | 3.2 | 3.2 | | 3.0 | | |
| \textcircled{1} (W/m · K) | | | | | | | | |
| Filler filling rate | 68.8 | | | | | | | |
| \textcircled{2} (volume %) | | | | | | | | |
| Heat conductivity | 9.5 | | | | | | | |
| \textcircled{2} (W/m · K) | | | | | | | | |

TABLE 2

| Example | 9 | 10 | 11 |
|---|---|---|---|
| Added reagent | Acetic acid/ | Lithium hydroxide | Acetic |
| (component \textcircled{1}/ | lithium acetate | monohydrate/— | acid/— |
| component \textcircled{2}) | | | |
| Addition amount | 0.61 weight | 0.43 weight | 0.61 weight |
| of component \textcircled{1} | part relative | part relative | part relative |
| | to zinc oxide | to zinc oxide | to zinc oxide |
| Addition amount | 0.5 weight | | |
| of component \textcircled{2} | part relative | | |
| | to zinc oxide | | |
| Addition amount | 3.5 weight | 3.5 weight | |
| of dispersant | parts relative | parts relative | |
| (POIZ 532A) | to zinc oxide | to zinc oxide | |
| Concentration | 500 | 1360 | |
| of slurry (g/l) | | | |
| Baking | 1000° C./ | 1200° C./ | 1000° C./ |
| temperature/ | 3 Hr | 3 Hr | 3 Hr |
| baking time | | | |
| Median size | 31.9 | 23.0 | |
| D50 (μm) | | | |
| D10 (μm) | 20.5 | 13.7 | |
| D90 (μm) | 50.6 | 38.3 | |
| D90/D10 | 2.5 | 2.8 | |
| Aspect ratio | 1.01 | 1.10 | 1.35 |
| Density (g/cm³) | 4.85 | 4.80 | 4.65 |
| Filler filling rate | 62.9 | | 62.9 |
| \textcircled{1} (volume %) | | | |
| Heat conductivity | 3.0 | | 4.6 |
| \textcircled{1} (W/m · K) | | | |
| Filler filling rate | 68.8 | | |
| \textcircled{2} (volume %) | | | |
| Heat conductivity | 5.3 | | |
| \textcircled{2} (W/m · K) | | | |

TABLE 3

| Comparative Example | 1 | 2 | 3 | 4 | 5 | 6 | 7 | 8 |
|---|---|---|---|---|---|---|---|---|
| Added reagent | | | | Ammonium | Ammonium | Hydrochloric | | |
| (component \textcircled{1}/ | | | | bromide/— | bromide/— | acid/— | | |
| component \textcircled{2}) | | | | | | | | |
| Addition amount | | | | 1.00 weight | 1.00 weight | 0.37 weight | | |
| of component \textcircled{1} | | | | parts relative | parts relative | part relative | | |
| | | | | to zinc oxide | to zinc oxide | to zinc oxide | | |
| Addition amount | | | | | | | | |
| of component \textcircled{2} | | | | | | | | |
| Addition amount | | | | | 3.5 weight | 3.5 weight | | |
| of dispersant | | | | | parts relative | parts relative | | |
| (POIZ 532A) | | | | | to zinc oxide | to zinc oxide | | |
| Concentration | | | 1200 | | 840 | 580 | | |
| of slurry (g/l) | | | | | | | | |
| Baking | | | 1000° C./3 Hr | 1150° C./3 Hr | 1000° C./3 Hr | 1000° C./3 Hr | | |
| temperature/ | | | | | | | | |
| baking time | | | | | | | | |
| Median size | | 0.2 | 13.3 | 10.2 | 14.4 | 13.2 | 28.4 | 33.5 |
| D50 (μm) | | | | | | | | |
| D10 (μm) | | 0.1 | 5.1 | 6.1 | 6.6 | 7.0 | 20.2 | 18.1 |
| D90 (μm) | | 0.5 | 47.4 | 16.8 | 27.6 | 23.1 | 42.0 | 57.0 |
| D90/D10 | | 4.3 | 9.3 | 2.8 | 4.2 | 3.3 | 2.1 | 3.1 |
| Aspect ratio | | | 1.53 | 1.37 | 1.45 | 1.39 | 1.07 | 1.05 |
| Density (g/cm³) | | 4.12 | 4.80 | 4.83 | 4.81 | 4.80 | | |
| Filler filling rate | 0 | 62.9 | | 62.9 | 62.9 | 62.9 | 62.9 | 62.9 |
| \textcircled{1} (volume %) | | | | | | | | |
| Heat conductivity | 0.3 | 1.4 | | 2.2 | 2.4 | 2.5 | 1.7 | 2.3 |
| \textcircled{1} (W/m · K) | | | | | | | | |
| Filler filling rate | | | | 66.7 | | | 68.8 | 68.8 |
| \textcircled{2} (volume %) | | | | | | | | |
| Heat conductivity | | | | 2.7 | | | 1.1 | 2.4 |
| \textcircled{2} (W/m · K) | | | | | | | | |

TABLE 4

| | | Compar. | | | | | | Compar. | Compar. |
|---|---|---|---|---|---|---|---|---|---|
| | | Ex. 1 | Ex. 1 | Ex. 1 | Ex. 9 | Ex. 9 | Ex. 11 | Ex. 2 | Ex. 4 |
| Mixing | EEA resin | 42.3 | 16.9 | 16.9 | 16.9 | 16.9 | 16.9 | 16.9 | 16.9 |
| amount | Zinc oxide particle of | | 168.0 | 218.4 | | | | | |
| (g) | Example 1 | | | | | | | | |
| | Zinc oxide particle of | | | | 168.0 | 218.4 | | | |
| | Example 9 | | | | | | | | |
| | Zinc oxide particle of | | | | | | 168.0 | | |
| | Example 11 | | | | | | | | |
| | Zinc oxide particle of | | | | | | | 168.0 | |
| | Comparative example 2 | | | | | | | | |
| | Zinc oxide particle of | | | | | | | | 168.0 |
| | Comparative example 4 | | | | | | | | |
| | Alumina of Comparative | | | | | | | | |
| | example 7 | | | | | | | | |
| | Alumina of Comparative | | | | | | | | |
| | example 8 | | | | | | | | |

| | | | | | | | | |
|---|---|---|---|---|---|---|---|---|
| Filling rate of filler (volume %) | 0.0 | 62.9 | 68.8 | 62.9 | 68.8 | 62.9 | 62.9 | 62.9 |
| Heat conductivity (W/m · K) | 0.3 | 3.3 | 9.5 | 3.0 | 5.3 | 4.6 | 1.4 | 2.2 |

| | | Compar. | Compar. | Compar. | Compar. | Compar. |
|---|---|---|---|---|---|---|
| | | Ex. 4 | Ex. 7 | Ex. 7 | Ex. 8 | Ex. 8 |
| Mixing | EEA resin | 16.9 | 16.9 | 16.9 | 16.9 | 16.9 |
| amount | Zinc oxide particle of | | | | | |
| (g) | Example 1 | | | | | |
| | Zinc oxide particle of | | | | | |
| | Example 9 | | | | | |
| | Zinc oxide particle of | | | | | |
| | Example 11 | | | | | |
| | Zinc oxide particle of | | | | | |
| | Comparative example 2 | | | | | |
| | Zinc oxide particle of | 198.8 | | | | |
| | Comparative example 4 | | | | | |
| | Alumina of Comparative | | 115.0 | 149.6 | | |
| | example 7 | | | | | |
| | Alumina of Comparative | | | | 115.0 | 149.6 |
| | example 8 | | | | | |

| | | | | | |
|---|---|---|---|---|---|
| Filling rate of filler (volume %) | 66.7 | 62.9 | 68.8 | 62.9 | 68.8 |
| Heat conductivity (W/m · K) | 2.7 | 1.7 | 1.1 | 2.3 | 2.4 |

As shown in Table 4, heat conductivity: 9.5 (W/m·K) was extremely increased by filling up the zinc oxide particle of Example 1 in high volume % (68.8 volume %). This was derived from the fact that the zinc oxide particle of Example 1 was spherical and high-density and has median size (D50) of 28.5 μm. Therefore, such zinc oxide particle of Comparative Example 4 having a median size (D50) of 10.2 μm could not make heat conductivity as high as Example 1 because the particle size was smaller than the zinc oxide particle of Example 1 and the particle was not spherical so the filling efficiency would become worse and it could not be filled up to 68.8 volume %.

From the results shown in Table 4, it was cleared that the exoergic filler of the present disclosure had superior property than the exoergic filler used wisely. It was cleared that, even if the filler was filled up densely or loosely, the exoergic property could be provided.

The zinc oxide particle of the present disclosure can be used suitably as the exoergic filler. In addition, the particle can be used for applications such as rubber accelerators, pigments for coating compositions and inks, such electronic components as ferrite and varistor, medicinal products and cosmetics.

### INDUSTRIAL APPLICABILITY

The zinc oxide particle of the present disclosure can be used suitably as the exoergic filler. In addition, the particle can be used for applications such as rubber accelerators, pigments for coating compositions and inks, such electronic components as ferrite and varistor, medicinal products and cosmetics.

1. A zinc oxide particle being high-density, which has density of 4.0 g/cm³ or more and median size (D50) of 17 to 10000 μm.

2. A method for producing a zinc oxide particle, comprising a step (1) of mixing a source of the zinc oxide particle with at least one compound selected from the group consisting of organic acids, organic bases, inorganic acids, inorganic bases, and salts thereof not containing a halogen to granulate, and a step (2) of baking the granulated particle obtained in said step (1) to obtain the zinc oxide particle according to claim 1.

3. The method for producing a zinc oxide particle according to claim 2,
wherein the organic acid, organic base, inorganic acid, inorganic base, or salt thereof is carboxylic acid, nitric acid or salts thereof.

4. An exoergic filler comprising the zinc oxide particle according to claim 1.

5. An exoergic resin composition comprising the zinc oxide particle according to claim 1.

6. An exoergic grease comprising the zinc oxide particle according to claim 1.

7. An exoergic coating composition comprising the zinc oxide particle according to a claim 1.
